(19) United States
(12) Patent Application Publication
(10) Pub. No.: US 2005/0072407 A1
(43) Pub. Date: Apr. 7, 2005

(54) Gasoline direct injection system

(76) Inventor: Chul Ho Yu, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/746,999

(22) Filed: Dec. 23, 2003

(30) Foreign Application Priority Data
Oct. 1, 2003 (KR) 10-2003-0068372

(51) Int. Cl. F02M 23/00

(52) U.S. Cl. 123/531

(57) ABSTRACT

A gasoline direct injection engine system provided with an air rail for supplying air and a fuel rail for supplying fuel comprises an air supply for adjusting the flow rate of intake air, pressurizing the intake air, and supplying the pressurized air to the air rail. A fuel supply pressurizes the fuel from a fuel tank and supplying the pressurized fuel to the fuel rail. At least one injector assembly is connected to both the air rail and the fuel rail, forming an air-fuel mixture and injecting the air-fuel mixture into a cylinder of an engine.

### CROSS-REFERENCE TO RELATED APPLICATIONS

This application claims priority of Korean Application No. 10-2003-006 8372, filed on Oct. 1, 2003, the disclosure of which is incorporated fully herein by reference.

### FIELD OF THE INVENTION

The presents invention relates to a system for gasoline direct injection, and, more particularly, to a system for a gasoline direct injection engine enabling more efficient injection of the air-fuel mixture to a cylinder.

### BACKGROUND OF THE INVENTION

For load conditions required by average driving, fuel is injected late in the compression stroke and the air-fuel mixture is stratified by tumble flow induced by a curved-top piston and an upright straight intake port, such that ultra-lean combustion is realized. However, when a gasoline direct injection (GDI) engine operates at higher loads or higher speeds, fuel injection takes place during the intake stroke. In this instance, the vaporization of fuel, which occurs in the cylinder at a late stage of the compression stroke, cools the air for better volumetric efficiency with a high compression ratio.

The conventional GDI engine has a high-pressure fuel pump driven by a cam shaft, a high-pressure swirl injector for swirling the injected fuel, and upright, straight intake ports such that the air and the fuel can be more efficiently mixed.

However, the conventional GDI engine has a complicated structure due to additional components such as the high pressure fuel pump, swirl injector, and so on. Furthermore, the particle size of the injected fuel from the injector is about 50 μm. When the fuel is injected near the ignition plug, wetting of the ignition plug, plug fouling, and carbon deposits occur such that the engine performance can deteriorate

### SUMMARY OF THE INVENTION

An exemplary gasoline direct injection engine system provided with an air rail for supplying air and a fuel rail for supplying fuel according to embodiments of the present invention comprises air supplying means for adjusting the flow rate of intake air, pressurizing the intake air, and supplying the pressurized air to the air rail; fuel supplying means for pressurizing the fuel from a fuel tank and supplying the pressurized fuel to the fuel rail; and at least one injector assembly connected to both the air rail and the fuel rail, for forming an air-fuel mixture and injecting the air-fuel mixture into a cylinder of the engine.

Preferably, the air supplying means comprises a throttle valve for adjusting the flow rate of intake air flowing to the air rail, an air compressor for compressing the intake air from the throttle valve, and an air pressure limit valve interposed between the air compressor and the air rail for limiting the air pressure.

Preferably, the fuel supplying means comprises a low pressure fuel pump for pressurizing the fuel in partial load (e.g. ultra-lean combustion mode), a high pressure fuel pump for pressurizing the fuel in full load (e.g. superior output mode), a first fuel pressure limit valve for limiting the pressure of the fuel pressurized by the low pressure fuel pump, and a second fuel pressure limit valve for limiting the pressure of the fuel pressurized by the high pressure fuel pump.

Preferably, the air supplying means further comprises a carbon canister for reserving vaporized fuel from the fuel tank, and a shut-off valve interposed between the carbon canister and the air compressor for controlling the vaporized fuel flow.

Preferably, the fuel supplying means further comprises a first check valve for preventing the fuel pressurized by the high pressure fuel pump from flowing backward, and a second check valve for preventing the fuel pressurized by the low pressure fuel pump from flowing backward.

Preferably, the injector assembly comprises a fuel injector, which is connected to the fuel rail and injects the fuel supplied from the fuel rail; and an air-fuel injector, which is connected to both the fuel injector and the air rail such that the fuel from the fuel injector and the air from the air rail are mixed for injecting the air-fuel mixture into a cylinder of the engine.

Preferably, the fuel injector and the air-fuel injector are connected in series.

Preferably, the fuel injection and the air-fuel injection are controlled by an injector driver connected to an ECU of the engine.

Preferably, the injector driver controls the air-fuel injector to inject the air-fuel mixture at the stage compression stroke stage.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a hydraulic circuit diagram according to an embodiment of the present invention;

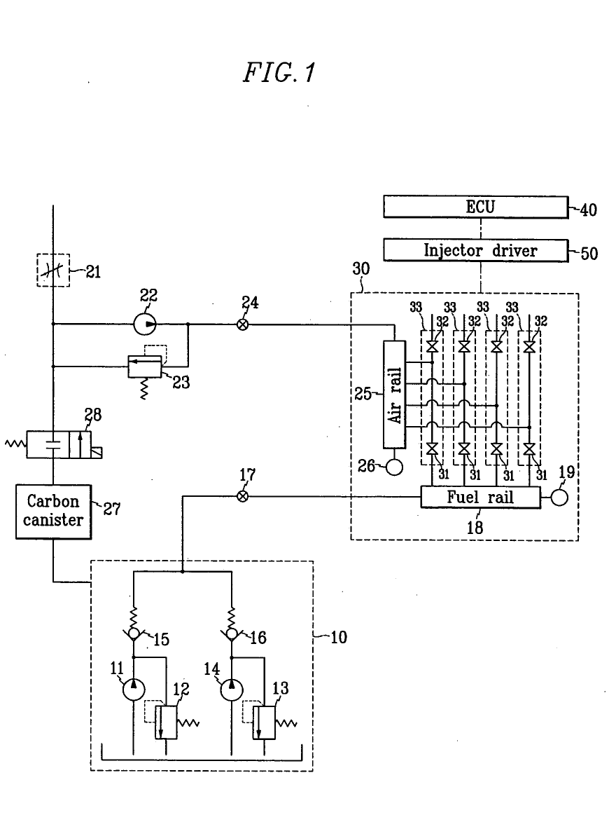

FIG. 2 is a sectional view of an injector assembly according to an embodiment of the present invention; and

FIG. 3 is a perspective view of the injector assembly of FIG. 2.

### DETAILED DESCRIPTION OF THE PREFERRED EMBODIMENTS

Hereinafter, a preferred embodiment of the present invention will be described in detail with reference to the accompanying drawings.

A fuel tank 10 for storing fuel is provided with a high pressure fuel pump 11 and a low pressure fuel pump 14. When a partial load is applied (e.g. ultra-lean combustion mode), and load conditions facilitate average driving, the low pressure fuel pump 14 pressurizes and sends fuel stored in the fuel tank 10 to a GDI engine 30. When full load is applied (e.g. superior output mode), and the GDI engine is operating at higher loads or at higher speeds, the high pressure fuel pump 11 pressurizes and sends the fuel stored in the fuel tank 10 to the GDI engine 30.

A first pressure limit valve 13 limits the pressure of the fuel pressurized by the low pressure fuel pump 14, and a second fuel pressure limit valve 12 limits the pressure of the fuel pressurized by the high pressure fuel pump 11. A first check valve 16 and a second check valve 15 respectively prevent the fuel sent by the low pressure fuel pump 14 and the high pressure fuel pump 11 from flowing backward. Furthermore, the pressure limit to open the first pressure limit valve 13 is set to be the same as the pressure limit to open the second check valve 15 such that the low pressure fuel pump 14 or the high pressure fuel pump 11 can be alternatively driven.

The pressure of the fuel sent by the fuel pumps 11, 14 is detected by the fuel pressure detector 19 and the fuel pressure is adjusted by a fuel pressure adjuster 17, which is controlled by the ECU based on the detected fuel pressure, and the fuel is supplied to a fuel rail 18. The air flow rate, which is determined by the throttle valve 21 as adjusted by the throttle position, is also controlled by the ECU 50.

A carbon canister 27 is connected to the fuel tank 10 such that vaporized fuel is stored therein. The throttle valve 21 and the carbon canister 27 are connected to an air compressor 22 such that intake flow from the throttle valve 21 and the vaporized fuel from the carbon canister 27 are compressed and supplied to an air rail 25. A shut-off valve 28, which controls the vaporized fuel flow, is interconnected between the carbon canister 27 and the air compressor 22.

An air pressure limit valve 23 limits the air pressure pressurized by the air compressor 22 by bypassing an excess thereof. The pressurized air sent by the air compressor 22 is detected by the air pressure detector 26 and the air pressure is adjusted by an air pressure adjuster 24, which is controlled by the ECU based on the detected air pressure, such that the air is supplied to an air rail 25.

The fuel supplied to the fuel rail 18 and the air supplied to the air rail 25 are mixed in a plurality of injector assemblies 33 such that the air-fuel mixture is directly injected into each cylinder of the engine 30.

Each injector assembly 33 comprises a fuel injector 31 and an air-fuel injector 32. The fuel injector 31 is connected to the fuel rail 18 and injects the fuel supplied from the fuel rail 18 into the air-fuel injector 32, while the air-fuel injector 32 is connected to both the fuel injector 31 and the air rail 25 such that the fuel from the fuel injector 31 and the air from the air rail 25 are mixed therein.

The plurality of injector assemblies 33 are controlled by an injector driver 50, which is connected to the ECU 40 such that the injector driver controls the injection timing and the amount of injected air-fuel mixture. Preferably, the injector driver 50 controls the injector assembly 33 to inject the air-fuel mixture in the compression stroke stage with respect to each cylinder.

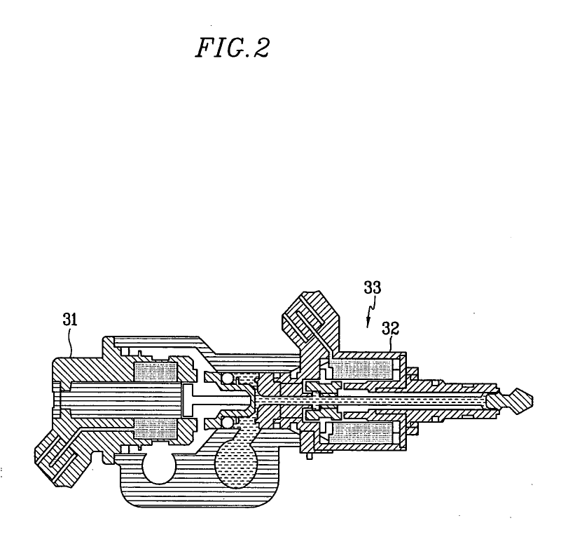

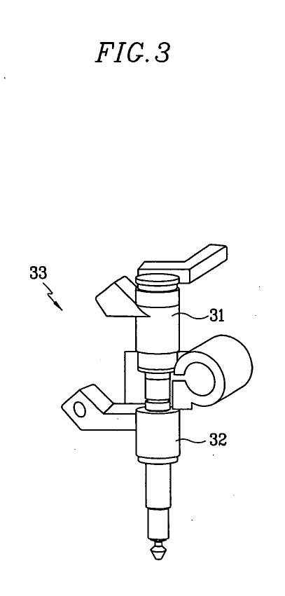

As shown in FIG. 2 and FIG. 3, the injector assembly 33 comprises the fuel injector 31 and the air-fuel injector 32, as described above. The fuel injector 31 and the air-fuel injector 32 are connected in series to constitute an injector assembly 33, which is provided to each cylinder of the engine 30.

The air-fuel injector 32 has a chamber for mixing the fuel injected by the fuel injector 31 and the air supplied from the air rail 25. The air supplied from the air rail 25 stands by in the chamber such that when the fuel is injected, the fuel and the air are mixed and the fuel is vaporized.

The vaporized air-fuel mixture is injected into the cylinder by the air-fuel injector 32 at the timing determined by the injection driver 50. The air-fuel mixture injected into the cylinder is ignited by an ignition plug mounted in the cylinder.

Preferably, the piston adapted in this invention has a recess on its top surface for concentrating the air-fuel mixture to near the ignition plug, and the injector assembly 33 is upright and pointed straight down into the cylinder.

According to the gasoline direct injection engine system, the air and the fuel are mixed in the injector assembly, and the air-fuel mixture is directly injected to the combustion chamber such that wetting of the ignition plug is prevented and the range of ultra-lean combustion can be enlarged.

Furthermore, the air-fuel mixture is directly supplied through the injector assembly such that the construction of the GDI engine becomes simple and the specific construction for generating tumble flow is no longer required.

1. A gasoline direct injection engine system provided with an air rail for supplying air and a fuel rail for supplying fuel, comprising:
air supplying means for adjusting the flow rate of intake air, pressurizing the intake air, and supplying the pressurized air to the air rail;
fuel supplying means for pressurizing the fuel from a fuel tank and supplying the pressurized fuel to the fuel rail; and
at least one injector assembly connected to both the air rail and the fuel rail, for forming an air-fuel mixture and injecting the air-fuel mixture into a cylinder of an engine.

2. The gasoline direct injection engine system of claim 1, wherein:
the air supplying means comprises a throttle valve for adjusting the flow rate of intake air flowing to the air rail, an air compressor for compressing the intake air from the throttle valve, and an air pressure limit valve interposed between the air compressor and the air rail for limiting the air pressure; and
the fuel supplying means comprises a low pressure fuel pump for pressurizing the fuel in partial load, a high pressure fuel pump for pressurizing the fuel in full load, a first fuel pressure limit valve for limiting the pressure of the fuel pressurized by the low pressure fuel pump, and a second fuel pressure limit valve for limiting the pressure of the fuel pressurized by the high pressure fuel pump.

3. The gasoline direct injection engine system of claim 2, wherein the air supplying means further comprises:
a carbon canister for reserving vaporized fuel from the fuel tank; and
a shut-off valve interposed between the carbon canister and the air compressor for controlling the vaporized fuel flow.

4. The gasoline direct injection engine system of claim 3, wherein the fuel supplying means further comprises:
a first check valve for preventing the fuel pressurized by the high pressure fuel pump from flowing backward; and
a second check valve for preventing the fuel pressurized by the low pressure fuel pump from flowing backward.

5. The gasoline direct injection engine system of claim 4, wherein the injector assembly comprises:
a fuel injector, connectable to the fuel rail and injects the fuel supplied from the fuel rail; and
an air-fuel injector, connected to the fuel injector and connectable to the air rail such that the fuel from the fuel injector and the air from the air rail are mixed for injecting the air-fuel mixture into the cylinder of the engine.

6. The gasoline direct injection engine system of claim 5, wherein the fuel injector and the air-fuel injector are connected in series.

7. The gasoline direct injection engine system of claim 5, wherein the fuel injection and the air-fuel injection are controlled by an injector driver connected to an ECU of the engine.

8. The gasoline direct injection engine system of claim 7, wherein the injector driver controls the air-fuel injector to inject the air-fuel mixture in the compression stroke stage.
